(19) United States
(12) Patent Application Publication
(10) Pub. No.: US 2015/0347831 A1
(43) Pub. Date: Dec. 3, 2015

(54) DETECTION DEVICE, DETECTION PROGRAM, DETECTION METHOD, VEHICLE EQUIPPED WITH DETECTION DEVICE, PARAMETER CALCULATION DEVICE, PARAMETER CALCULATING PARAMETERS, PARAMETER CALCULATION PROGRAM, AND METHOD OF CALCULATING PARAMETERS

(71) Applicant: DENSO CORPORATION, Kariya-city (JP)

(72) Inventors: YUKIMASA TAMATSU, Okazaki-shi (JP); KENSUKE YOKOI, Kariya-shi (JP); IKURO SATO, Yokohama (JP)

(21) Appl. No.: 14/722,397

(22) Filed: May 27, 2015

(30) Foreign Application Priority Data
May 28, 2014 (JP) 2014-110079
Dec. 5, 2014 (JP) 2014-247069

(51) Int. Cl. G06K 9/00; G06K 9/66; H04N 5/14; G06K 9/62

(52) U.S. Cl. CPC G06K 9/00369; G06K 9/6267; G06K 9/66; H04N 5/144

(57) ABSTRACT

A detection device has a neural network process section performing a neural network process using parameters to calculate and output a classification result and a regression result of each of frames in an input image. The classification result shows a presence of a person in the input image. The regression result shows a position of the person in the input image. The parameters are determined based on a learning process using a plurality of positive samples and negative samples. The positive samples have segments of a sample image containing at least a part of the person and a true value of the position of the person in the sample image. The negative samples have segments of the sample image containing no person.

### CROSS-REFERENCE TO RELATED APPLICATION

This application is related to and claims priority from Japanese Patent Applications No. 2014-110079 filed on May 28, 2014, and No. 2014-247069 filed on Dec. 5, 2014, the contents of which are hereby incorporated by reference.

### BACKGROUND OF THE INVENTION

1. Field of the Invention

The present invention relates to detection devices capable of detecting a person such as a pedestrian in an image, and detection programs and detection methods thereof. Further, the present invention relates to vehicles equipped with the detection device, parameter calculation devices capable of calculating parameters to be used by the detection device, and parameter calculation programs and methods thereof.

2. Description of the Related Art

In order to assist a driver of an own vehicle to drive safety, there are various technical problems. One of the problems is to correctly and quickly detect one or more pedestrians in front of the own vehicle. In a usual traffic environment, it often happens that one or more pedestrians are hidden behind other motor vehicles or traffic signs on a driveway. It is accordingly necessary to have an algorithm to correctly detect the presence of a pedestrian even if only a part of the pedestrian can be seen, i.e. a part of the pedestrian is hidden.

There is a non-patent document 1, X. Wang, T. X. Han, S. Yan, “An-HOG-LBP Detector with partial Occlusion Handling”, IEEE 12th International Conference on Computer Vision (ICV), 2009, which shows a method of detecting a pedestrian in an image obtained by an in-vehicle camera. The in-vehicle camera obtains the image in front of the own vehicle. In this method, an image feature value is obtained from a rectangle segment in the image obtained by the in-vehicle camera. A linear discriminant unit judges whether or not the image feature value involves a pedestrian. After this, the rectangle segment is further divided into small-sized blocks. A partial score of the linear discriminant unit is assigned to each of the small-sized blocks. A part of the pedestrian, which is hidden in the image, is estimated by performing a segmentation on the basis of a distribution of the scores. A predetermined partial model is applied to the remaining part of the pedestrian in the image, which is not hidden, in order to compensate the scores.

This non-patent document 1 previously described concludes that this method correctly detects the presence of the pedestrian even if a part of the pedestrian is hidden in the image.

The method disclosed in the non-patent document 1 is required to independently generate partial models of a person in advance. However, this method does not clearly indicate dividing a person in the image into a number of segments having different sizes.

### SUMMARY

It is therefore desired to provide a detection device, a detection program, and a detection method capable of receiving an input image and correctly detecting the presence of a person (one or more pedestrians, for example) in the input image even if a part of the person is hidden without generating any partial model. It is further desired to provide a vehicle equipped with the detection device. It is still further desired to provide a parameter calculation device, a parameter calculation program and a parameter calculation method capable of calculating parameters to be used by the detection device.

That is, an exemplary embodiment provides a detection device having a neural network processing section. This neural network processing section performs a neural network process using predetermined parameters in order to calculate and output a classification result and a regression result of each of a plurality of frames in an input image. In particular, the classification result represents a presence of a person in the input image. The regression result represents a position of the person in the input image. The parameters are determined on the basis of a learning process using a plurality of positive samples and negative samples. Each of the positive samples has a set of a segment of a sample image containing at least a part of a person and a true value (actual value) of the position of the person in the sample image. Each of the negative samples has a segment of the sample image containing no person.

The detection device having the structure previously described performs a neural network process using the parameters which have been determined on the basis of segments in a sample image which contain at least a part of a person. Accordingly, it is possible for the detection device to correctly detect the presence of a person such as a pedestrian in the input image with high accuracy even of a part of the person is hidden.

It is possible for the detection device to have an integration section capable of integrating the regression results of the position of the person in the frames which have been classified to the presence of the person. The integration section further specifies the position of the person in the input image.

It is preferable for the number of the parameters not to depend on the number of the positive samples and the negative samples. This structure makes it possible to increase the number of the positive samples and the number of the negative samples without increasing the number of the parameters. Further this makes it possible to increase the detection accuracy of detecting the person in the input image without increasing a memory size and memory access duration.

It is acceptable that the position of the person contains the lower end position of the person. In this case, the in-vehicle camera mounted in the vehicle body of the vehicle generates the input image, and the detection device further has a calculation section capable of calculating a distance between the vehicle body of the own vehicle and the detected person on the basis of the lower end position of the person. This makes it possible to guarantee the driver of the own vehicle can drive safety because the calculation section calculates the distance between the own vehicle and the person on the basis of the lower end position of the person.

It is possible for the position of the person to contain a position of a specific part of the person in addition to the lower end position of the person. It is also possible for the calculation section to adjust, i.e. correct the distance between the person and the vehicle body of the own vehicle by using the position of the person at a timing t and the position of the person at the timing t+1 while assuming that the height measured from the lower end position of the person and the position of the specific part of the person has a constant value, i.e. does not vary. The position of the person at the timing t is obtained by processing the image captured by the in-vehicle camera at the timing t and transmitted from the in-vehicle camera. The position of the person at the timing t+1 is obtained by processing the image captured at the timing t+1 and transmitted from the in-vehicle camera.

In a concrete example, it is possible for the calculation section to correct the distance between the person and the vehicle body of the own vehicle by solving a state space model using time-series observation values. The state space model comprises an equation which describes a system model and an equation which describes an observation model. The system model shows a time expansion of the distance between the person and the vehicle body of the own vehicle, and the assumption in which the height measured from the lower end position of the person to the specific part of the person has a constant value, i.e. does not vary. The observation model shows a relationship between the position of the person and the distance between the person and the vehicle body of the own vehicle.

This correction structure of the detection device increases the accuracy of estimating the distance (distance estimation accuracy) between the person and the vehicle body of the own vehicle.

It is possible for the calculation section to correct the distance between the person and the vehicle body of the own vehicle by using the upper end position of the person as the specific part of the person and the assumption in which the height of the person is a constant value, i.e. is not variable.

It is acceptable that the position of the person contains a central position of the person in a horizontal direction. This makes it possible to specify the central position of the person, and for the driver to recognize the location of the person in front of the own vehicle with high accuracy.

It is possible for the integration section to perform a grouping of the frames in which the person is present, and integrate the regression results of the person in each of the grouped frames. This makes it possible to specify the position of the person with high accuracy even if the input image contains many persons (i.e. pedestrians).

It is acceptable for the integration section in the detection device to integrate the regression results of the position of the person on the basis of the regression results having a high regression accuracy in the regression results of the position of the person. This structure makes it possible to increase the detection accuracy of detecting the presence of the person in front of the own vehicle because of using the regression results having a high regression accuracy.

It is acceptable to determine the parameters so that a cost function having a first term and a second term are convergent. In this case, the first term is used by the classification regarding whether or not the person is present in the input image. The second term is used by the regression of the position of the person. This makes it possible for the neural network process section to perform both the classification whether or not the person is present in the input image and the regression of the position of the person in the input image.

It is acceptable that the position of the person includes positions of a plurality of parts of the person, and the second term has coefficients corresponding to the positions of the parts of the person, respectively. This structure makes it possible to prevent one or more parts selected from many parts of the person from being dominant or not being dominant by using proper parameters.

In accordance with another aspect of the present invention, there is provided a detection program capable of performing a neural network process using predetermined parameters executed by a computer. The neural network process is capable of obtaining and outputting a classification result and a regression result of each of a plurality of frames in an input image. The classification result shows a presence of a person in the input image. The regression result shows a position of the person in the input image. The parameters are determined by performing a learning process on the basis of a plurality of positive samples and negative samples. Each of the positive samples has a set of a segment in a sample image containing at least a part of the person and a true value (actual value) of the position of the person in the sample image. Each of the negative samples has a segment of the sample image containing no person.

This detection program makes it possible to perform the neural network process using the parameters on the basis of the segments containing at least a part of the person. It is accordingly for the detection program to correctly detect the presence of the person even if a part of the person is hidden without generating a partial model.

In accordance with another aspect of the present invention, there is provided a detection method of calculating parameters to be used by a neural network process. The parameters are calculated by performing a learning process on the basis of a plurality of positive samples and negative samples. Each of the positive samples has a set of a segment of a sample image containing at least a part of the person and a true value (actual value) of the position of the person in the sample images. Each of the negative samples has a segment of the sample image containing no person. The detection method further performs a neural network process using the calculated parameters, and outputs classification results of a plurality of frames in an input image. The classification result represents a presence of a person in the input image. The regression result indicates a position of the person in the input image.

Because this detection method performs the neural network process using parameters on the basis of segments of a sample image containing at least a part of a person, it is possible for the detection method to correctly detect the presence of the person with high accuracy without using any partial model even if a part of the person is hidden by another vehicle or a traffic sign, for example.

In accordance with another aspect of the present invention, there is provided a vehicle having a vehicle body, an in-vehicle camera, a neural network processing section, an integration section, a calculation section, and a display section. The in-vehicle camera is mounted in the vehicle body and is capable of generating an image of a scene in front of the vehicle body. The neural network processing section is capable of inputting the image as an input image transmitted from the in-vehicle camera, performing a neural network process using predetermined parameters, and outputting classification results and regression results of each of a plurality of frames in the input image. The classification results show a presence of a person in the input image. The regression results show a lower end position of the person in the input image.

The integration section is capable of integrating the regression results of the position of the person in the frames in which the person is presence, and specifying a lower end position of the person in the input image. The calculation section is capable of calculating a distance between the person and the vehicle body on the basis of the specified lower end position of the person. The display device is capable of displaying an image containing the distance between the person and the vehicle body. The predetermined parameters are determined by learning on the basis of a plurality of positive samples and negative samples. Each of the positive samples has a set of a segment of a sample image containing at least a part of the person and a true value of the position of the person in the sample images. Each of the negative samples has a segment of the sample image containing no person.

Because the neural network processing section on the vehicle performs the neural network process using the parameters which have been determined on the basis of the segments in the sample image containing at least a part of a person, it is possible to correctly detect the presence of the person in the input image without using any partial model even if a part of the person is hidden by another vehicle or a traffic sign, for example.

In accordance with another aspect of the present invention, there is provided a parameter calculation device capable of performing learning of a plurality of positive samples and negative samples, in order to calculate parameters to be used by a neural network process of an input image. Each of the positive samples has a set of a segment of a sample image containing at least a part of the person and a true value of the position of the person in the sample images. Each of the negative samples has a segment of the sample image containing no person.

Because this makes it possible to calculate the parameters on the basis of segments of the sample image which contains at least a part of a person, it is possible to correctly detect the presence of the person in the input image by performing the neural network process using the calculated parameters without generating any partial model even if a part of the person is hidden by another vehicle or a traffic sign, for example.

In accordance with another aspect of the present invention, there is provided a parameter calculation program, to be executed by a computer, of performing a function of a parameter calculation device which performs learning of a plurality of positive samples and negative samples, in order to calculate parameters for use in a neural network process of an input image. Each of the positive samples has a set of a segment of a sample image containing at least a part of the person and a true value of the position of the person in the sample images. Each of the negative samples has a segment of the sample image containing no person.

Because this makes it possible to calculate the parameters on the basis of segments of the sample image which contains at least a part of a person, it is possible to correctly detect the presence of the person in the input image by performing the neural network process using the calculated parameters without generating any partial model even if a part of the person is hidden by another vehicle or a traffic sign, for example.

In accordance with another aspect of the present invention, there is provided a method of calculating parameters for use in a neural network process of an input image, by performing learning using a plurality of positive samples and negative samples. Each of the positive samples has a set of a segment of a sample image containing at least a part of the person and a true value of the position of the person in the sample images. Each of the negative samples has a segment of the sample image containing no person.

Because this method makes it possible to calculate the parameters on the basis of segments of the sample image which contains at least a part of a person, it is possible to correctly detect the presence of the person in the input image by performing the neural network process using the calculated parameters without generating any partial model even if a part of the person is hidden by another vehicle or a traffic sign, for example.

### BRIEF DESCRIPTION OF THE DRAWINGS

A preferred, non-limiting embodiment of the present invention will be described by way of example with reference to the accompanying drawings, in which:

FIG. 1 is a view showing a schematic structure of a motor vehicle (own vehicle) equipped with an in-vehicle camera 1, a detection device 2, a display device 3, etc. according to a first exemplary embodiment of the present invention;

FIG. 2 is a block diagram showing a schematic structure of the detection device 2 according to the first exemplary embodiment of the present invention;

FIG. 3 is a flow chart showing a parameter calculation process performed by a parameter calculation section 5 according to the first exemplary embodiment of the present invention;

FIG. 4A and FIG. 4B are views showing an example of positive samples;

FIG. 5A and FIG. 5B are views showing an example of negative samples;

FIG. 6A to FIG. 6D are views showing a process performed by a neural network processing section 22 in the detection device 2 according to the first exemplary embodiment of the present invention;

FIG. 7 is a view showing a structure of a convolution neural network (CNN) used by the neural network processing section 22 in the detection device 2 according to the first exemplary embodiment of the present invention;

FIG. 8 is a view showing a schematic structure of an output layer 223c in a multi-layered neural network structure 223;

FIG. 9 is a view showing an example of real detection results detected by the detection device 2 according to the first exemplary embodiment of the present invention shown in FIG. 2;

FIG. 10 is a flow chart showing a grouping process performed by an integration section 23 in the detection device 2 according to the first exemplary embodiment of the present invention;

FIG. 11 is a view showing a relationship between a lower end position of a person and an error, i.e. explaining an estimation accuracy of a lower end position of a person;

FIG. 12 is a view showing a process performed, by a calculation section 24 in the detection device 2 according to the first exemplary embodiment of the present invention;

FIG. 13 is a view showing schematic image data generated by an image generation section 25 in the detection device 2 according to the first exemplary embodiment of the present invention;

FIG. 14 is a view explaining a state space model to be used by the detection device according to a second exemplary embodiment of the present invention;

FIG. 15A is a view showing experimental results of distance estimation performed by the detection device according to the second exemplary embodiment of the present invention; and

FIG. 15B is a view showing experimental results in accuracy of distance estimation performed by the detection device according to the second exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

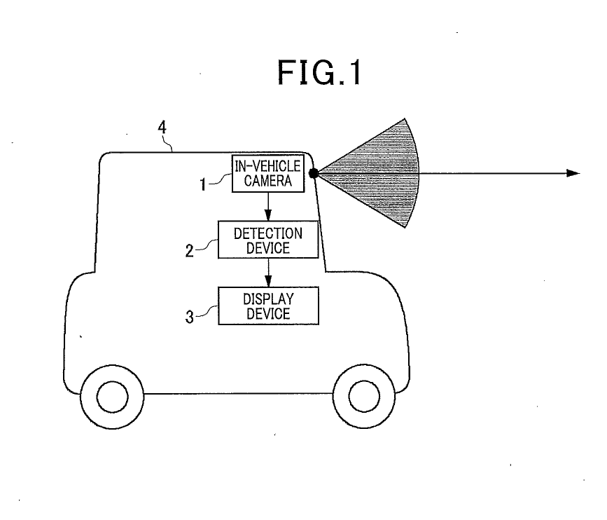

A description will be given of a first exemplary embodiment with reference to FIG. 1 to FIG. 13.

FIG. 1 is a view showing a schematic structure of a motor vehicle equipped with an in-vehicle camera 1, a detection device 2, a display device 3, etc. according to the first exemplary embodiment.

The in-vehicle camera 1 is mounted in the own vehicle so that an optical axis of the in-vehicle camera 1 is toward a horizontal direction, and the in-vehicle camera 1 is hidden in a driver of the own vehicle. For example, the in-vehicle camera 1 is arranged on the rear side of a rear-view mirror in a vehicle body 4 of the own vehicle. It is most preferable for a controller (not shown) to always direct the in-vehicle camera 1 to the horizontal direction with high accuracy. However, it is acceptable for the controller to direct the optical axis of the in-vehicle camera to the horizontal direction approximately. The in-vehicle camera 1 obtains an image of a front view scene of the own vehicle, and transmits the obtained image to the detection device 2. When the detection device 2 uses the image transmitted from one camera, i.e. from the in-vehicle camera 1 only, this makes it possible to provide a simple structure of an overall system of the detection device 2.

The detection device 2 receives the image transmitted from the in-vehicle camera 1. The detection device 2 detects whether or not a person such as a pedestrian is present in the received image. When the detection result indicates that the image contains a person, the detection device 2 further detects a location of the detected person in the image data. The detection device 2 generates image data representing the detected results.

In general, the display device 3 is arranged on a dash board or an audio system of the own vehicle. The display device 3 displays information regarding the detected results, i.e. the detected person, and further displays a location of the detected person when the detected person is present in front of the own vehicle.

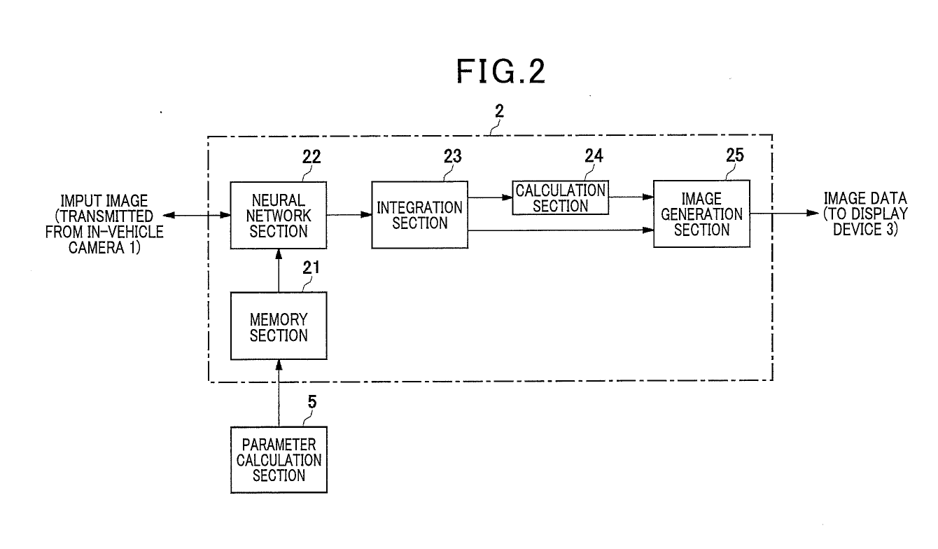

FIG. 2 is a block diagram showing a schematic structure of the detection device 2 according to the exemplary embodiment. The detection device 2 has a memory section 21, a neural network processing section 22, an integration section 23, a calculation section 24, and an image generation section 25. It is possible to provide a single device or several devices in which these sections 21 to 25 are integrated. It is acceptable to use software programs capable of performing the functions of a part or all of these sections 21 to 25. A computer or hardware devices perform the software programs.

A description will now be given of the components of the detection device 2, i.e. the memory section 21, the neural network processing section 22, the integration section 23, the calculation section 24 and the image generation section 25.

As shown in FIG. 2, a parameter calculation section 5 supplies parameters to the detection device 2. The parameter calculation section 5 calculates parameters, i.e. weighted values in advance, and stores the calculated parameters into the memory section 21 in the detection device 2. These parameters (weighted values) are used by a convolutional neural network (CNN) process. It is possible for another device (not shown) to have the parameter calculation section 5. It is also possible for the detection device 2 to incorporate the parameter calculation section 5. It is further possible to use software programs capable of calculating the parameters (weighted values).

The neural network processing section 22 in the detection device 2 receives, i.e. inputs the image (hereinafter, input image) obtained by and transmitted from the in-vehicle camera 1. The detection device 2 divides the input image into a plurality of frames.

The neural network processing section 22 performs the neural network process, and outputs classification results and regression results. The classification results indicate an estimation having a binary value (for example, 0 or 1) which indicates whether or not a person such as a pedestrian is present in each of the frames in the input image. The regression results indicate an estimation of continuous values regarding a location of a person in the input image.

After performing the neural network process, the neural network processing section 22 uses the weighted values W stored in the memory section 21.

The classification result indicates the estimation having a binary value (0 or 1) which indicates whether or not a person is present. The regression result indicates the estimation of continuous values regarding the location of the person in the input image.

The detection device 2 according to the first exemplary embodiment uses the position of a person consisting of an upper end position (a top head) of the person, a lower end position (a lower end) of the person, and a central position of the person in a horizontal direction. However, it is also acceptable for the detection device 2 to use, as the position of the person, an upper end position, a lower end position, and a central position in a horizontal direction of a partial part of the person or other positions of the person. The first exemplary embodiment uses the position of the person consisting of the upper end position, the lower end position and the central position of the person.

The integration section 23 integrates the regression results, i.e. consisting of the upper end position, the lower end position, and the central position of the person in a horizontal direction, and specifies the upper end position, the lower end position, and the central position of the person. The image generation section 25 calculates a distance between the person and the vehicle body 4 of the own vehicle on the basis of the location of the person, i.e. the specified position of the person.

As shown in FIG. 2, the image generation section 25 generates image data on the basis of the results of the processes transmitted from the integration section 23 and the calculation section 24. The image generation section 25 outputs the image data to the display device 3. The display device 3 displays the image data outputted from the image generation section 25. It is preferable for the image generation section 25 to generate distance information between the detected person in front of the own vehicle and the vehicle body 4 of the own vehicle. The display device 3 displays the distance information of the person.

A description will now be given of each of the sections.

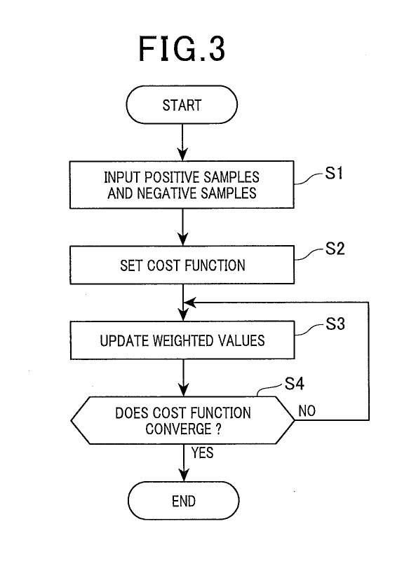

FIG. 3 is a flow chart showing a parameter calculation process performed by the parameter calculation section 5 according to the first exemplary embodiment. The parameter calculation section 5 stores the calculated weighted values (i.e. parameters) into the memory section 21. The calculation process of the weighted values will be explained. The weighted values (parameters) will be used in the CNN process performed by the detection device 2.

In step S1 shown in FIG. 3, the parameter calculation section 5 receives positive samples and negative samples as supervised data (or training data).

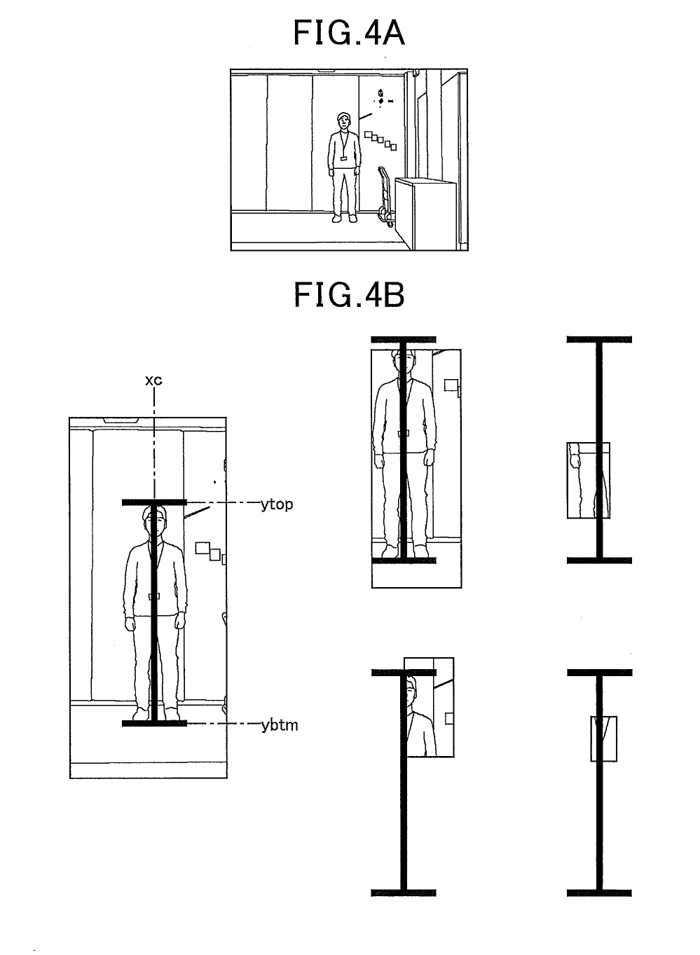

FIG. 4A and FIG. 4B are views showing an example of a positive sample. The positive sample is a pair comprised of 2-dimensional array image and corresponding target data. The CNN process inputs the 2-dimensional array image, and outputs the target data items corresponding to the 2-dimensional array image. The target data items indicate whether or not a person is present in the 2-dimensional array image, an upper end position, a lower end position, and a central position of the person.

In general, the CNN process uses as a positive sample the sample image shown in FIG. 4A which includes a person. It is also possible for the CNN process to use a grayscale image or RGB (Red-Green-Blue) color image.

As shown in FIG. 4B, the sample image shown in FIG. 4A is divided into segments so that each of the segments contains a part of a person or the overall person. It is possible for the segments to have different sizes, but each of the segments having different sizes has a same aspect ratio. Each of the segments is deformed, i.e., the shape of each of the segments is changed to have a small sized image having the same size as each other.

The parts of the person indicate a head part, a shoulder part, a stomach part, an arm part, a leg part, an upper body part, a lower body part of the person, and a combination of some parts of the person or an overall person. It is preferable for the small sized parts to represent many different parts of the person. Further, it is preferable that the small sized images show different positions of the person, for example, a part of the person or the image of the overall person is arranged at the center position or the end position in a small sized image. Still further, it is preferable to prepare many small sized images having different sized parts (large sized parts and small sized parts) of the person.

For example, the detection device 2 shown in FIG. 2 generates small sized images from many images (for example, several thousand images). It is possible to correctly perform the CNN process without a position shift by using the generated small sized images.

Each of the small sized images corresponds to a true value in a coordinates of the upper end position, the lower end position, and the central position as the location of the person.

FIG. 4A shows a relative coordinate of each small sized image, not an absolute coordinate of the small sized image in the original image. For example, the upper end position, the lower end position, and the central position of the person is defined in a X-Y coordinate system, where a horizontal direction is designated with the x-axis, a vertical direction is indicated by the y-axis, and the central position in the small sized image is an origin of the X-Y coordinate system. Hereinafter, the true value of the upper end position, the true value of the lower end position, and the true value (actual value) of the central position in the relative position will be designated as the “upper end position ytop”, the “lower end position ybtm”, and the “central position xc”, respectively.

The parameter calculation section 5 inputs each of the small sized images and the upper end position ytop, the lower end position ybtm, and the central position xc thereof.

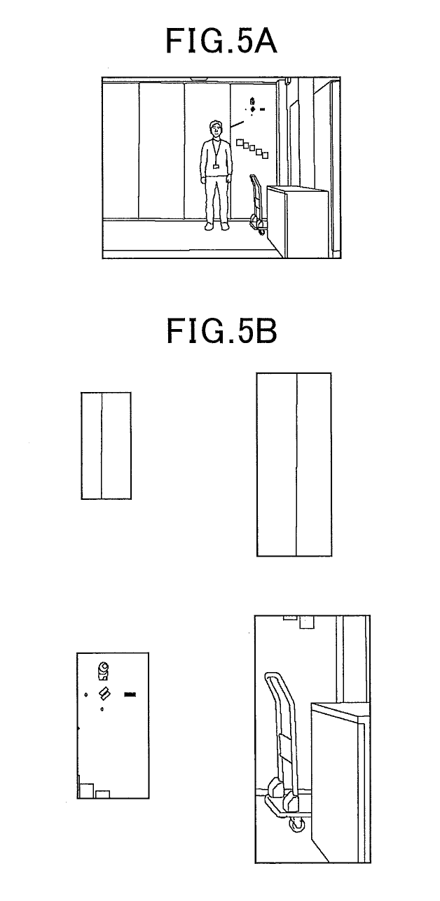

FIG. 5A and FIG. 5B are views showing an example of a negative sample.

The negative sample is a pair of 2-dimensional array image and target data items. The CNN inputs the 2-dimensional array image and outputs the target data items corresponding to the 2-dimensional array image. The target data items indicate that no person is present in the 2-dimensional array image.

The sample image containing a person (see FIG. 5A) and the image containing no person are used as negative samples.

As shown in FIG. 5B, a part of the sample image is divided into segments having different sizes so that the segments not contain a part of the person or the entire person, and have a same aspect ratio. Each of the segments is deformed, i.e. averaged to have a small sized image having a same size. Further, it is preferable that the small sized images correspond to the segments having different sizes and positions of the person. These small sized images are generated on the basis of many images (for example, several thousand images).

The parameter calculation section 5 inputs the negative samples composed of these small sized images previously described. Because the negative samples do not contain a person, it is not necessary for the negative samples to have any position information of a person.

In step S2 shown in FIG. 3, the parameter calculation section 5 generates a cost function E(W) on the basis of the received positive samples and the received negative samples. The parameter calculation section 5 according to the first exemplary embodiment generates the cost function E(W) capable of considering the classification and the regression. For example, the cost function E(W) can be expressed by the following equation (1).

$$E ( W ) = {\sum }_{n = 1}^{N} ( {G}_{n} ( W ) + {H}_{n} ( W ) ) \qquad ( 1 )$$

where N indicates the total number of the positive samples and the negative samples, W indicates a general term of a weighted value of each of the layers in the neural network. The weighted value W (as the general term of the weighted values of the layers of the neural network) is an optimal value so that the cost function E(W) has a small value.

The first term on the right-hand side of the equation (1) indicates the classification (as the estimation having a binary value whether or not a person is present). For example, the first term on the right-hand side of the equation (1) is defined as a negative cross entropy by using the following equation (2).

Gₙ(W)=−cₙ ln f_{cl}(xₙ;W)−(1−cₙ)ln(1−f_{cl}(xₙ;W)) (2)

where cₙ is a right value of the classification of n-th sample xₙ and has a binary value (0 or 1). In more detail, cₙ has a value of 1 when the positive sample is input, and has a value of 0 when a negative sample is input. The term of fc₁(xₙ; W) is called as the sigmoid function. This sigmoid function fc₁(xₙ; W) is a classification output corresponding to the sample xₙ and is within a range of more than 0 and less than 1.

For example, when a positive sample is input, i.e., cₙ=1, the equation (2) can be expressed by the following equation (2a).

Gₙ(W)=−ln f_{cl}(xₙ;W) (2a)

In order to reduce the value of the cost function E(W), the weighted value is optimized, i.e. has an optimal value so that the sigmoid function fc₁(xₙ; W) approaches the value of 1.

On the other hand, when a negative sample is input, i.e., cₙ=0, the equation (2) can be expressed by the following equation (2b).

Gₙ(W)=−ln(1−f_{cl}(xₙ;W)) (2b)

In order to reduce the value of the cost function E(W), the weighted value is optimized so that the sigmoid function fc₁(xₙ; W) approaches the value of zero.

As can be understood from the description previously described, the weighted value W is optimized so that the value of the sigmoid function fc₁(xₙ; W) approaches cₙ.

The second term on the equation (2) indicates the regression (as the estimation of the continuous values regarding a location of a person). The second term on the equation (2) is a sum of square of an error in the regression, for example, can be defined by the following equation (3).

$${H}_{n} ( W ) = {c}_{n} {\sum }_{j = 1}^{3} {( {f}_{re}^{j} ( {x}_{n} ; W ) - {r}_{n}^{j} )}^{2} \qquad ( 3 )$$

where rₙ¹ indicates a true value of the central position xc of a person in the n-th positive sample, rₙ² is a true value of the upper end position ytop of the person in the n-th positive sample, and rₙ³ is a true value of the lower end position ybtm of the person in the n-th positive sample.

Further, fᵣₑ¹ (xₙ; W) is an output of the regression of the central position of the person in the n-th positive sample, fᵣₑ² (xₙ; W) is an output of the regression of the upper end position of the person in the n-th positive sample, and fᵣₑ³ (xₙ; W) is an output of the regression of the lower end position of the person in the n-th positive sample.

In order to reduce the value of the cost function E(W), the weighted value is optimized so that the sigmoid function fᵣₑ^{j} (xₙ; W) approaches the value of the true value rₙ^{j} (j=1, 2 and 3).

In a more preferable example, it is possible to define the second term in the equation (2) by the following equation (3′) in order to adjust the balance between the central position, the upper end position and the lower end position of the person, and the balance between the classification and the regression.

$${H}_{n} ( W ) = {c}_{n} {\sum }_{j = 1}^{3} {{α}_{j} ( {f}_{re}^{j} ( {x}_{n} ; W ) - {r}_{n}^{j} )}^{2} \qquad ( {3}^{′} )$$

In the equation (3′), the left term (fᵣₑ^{j} (xₙ; W)−rₙ^{j})² is multiplied by the coefficient αⱼ. That is, the equation (3′) has coefficients α₁, α₂ and α₃ regarding the central position, the upper end position and the lower end position of the person.

That is, when α₁=α₂=α₃=1, the equation (3′) becomes equal to the equation (3).

The coefficients αⱼ (j=1, 2 and 3) are predetermined constant values. Proper determination of the coefficients αⱼ allows the detection device 2 to prevent each of j=1, 2, and 3 in the second term of the equation (3′) (which correspond to the central position, the upper end position and the lower end position of the person, respectively) from being dominated (or non-dominated).

In general, a person has a height which is larger than a width. Accordingly, the estimated central position of a person has a low error. On the other hand, as compared with the error of the height, the estimated upper end position of the person and the estimated lower end position of the person have a large error. Accordingly, when the equation (3) is used, the weighted values W are optimized to reduce an error of the upper end position and an error of the lower end position of the person preferentially. As a result, this makes it difficult to reduce the regression accuracy of the central position of the person with the increase of learning.

In order to avoid this problem, it is possible to increase the coefficient α₁ rather than the coefficients α₂ and α₃ by using the equation (3′). Using the equation (3′) makes it possible to output the correct regression result of the central position, the upper end position and the lower end position of the person.

Similarly, it is possible to prevent one of the classification and the regression from being dominated by using the coefficients αⱼ. For example, when the result of the classification has a high accuracy, but the result of the regression has a low accuracy by using the equation (3), it is sufficient to increase each of the coefficients α₁, α₂, α₃ by one.

In step S3 shown in FIG. 3, the parameter calculation section 5 updates the weighted value W for the cost function (W). More specifically, the parameter calculation section 5 updates the weighted value W on the basis of the error back-propagation method by using the following equation (4).

$$W ← W - ε \frac{\partial E}{\partial W} , \\ 0 < ε << 1 \qquad ( 4 )$$

The operation flow goes to step S4. In step S4, the parameter calculation section 5 judges whether or not the cost function (W) has been converged.

When the judgment result in step S4 indicates negation (“NO” in step S4), i.e. has not been converged, the operation flow returns to step S3. In step S3, the parameter calculation section 5 updates the weighted value W again. The process in step S3 and step S4 is repeatedly performed until the cost function E(W) becomes converged, i.e. the judgment result in step S4 indicates affirmation (“YES” in step S4). The parameter calculation section 5 repeatedly performs the process previously described to calculate the weighted values W for the overall layers in the neural network.

The CNN is one of forward propagation types of neural networks. A signal in one layer is a weight function between a signal in a previous layer and a weight between layers. It is possible to differentiate this function. This makes it possible to optimize the weight W by using the back error-propagation method, like the usual neural network.

As previously described, it is possible to obtain the optimized cost function E(W) within the machine learning. In other words, it is possible to calculate the weighted values on the basis of the learning of various types of positive samples and negative samples. As previously described, the positive sample contains a part of the body of a person. Accordingly, without performing the learning process of one or more partial models, the neural network processing section 22 in the detection device 2 can detect the presence of a person and the location of the person with high accuracy even if a part of the person is hidden by another vehicle or a traffic sign in the input image. That is, the detection device 2 can correctly detect the lower end part of the person even if a specific part of the person is hidden, for example, the lower end part of the person is hidden or presence in the outside of the image. Further, it is possible for the detection device 2 to correctly detect the presence of a person in the images even if the size of the person varies in the images because of using many positive samples and negative samples having different sizes.

The number of the weighted values calculated by the detection device 2 previously described does not depend on the number of the positive sample's and negative samples. Accordingly, the number of the weighted values W is not increased even if the number of the positive samples and the negative samples is increased. It is therefore possible for the detection device 2 according to the first exemplary embodiment to increase its detection accuracy by using many positive samples and negative samples without increasing the memory size of the memory section 21 and the memory access period of time.

A description will now be given of the neural network processing section 22 shown in FIG. 2 in detail.

The neural network processing section 22 performs a neural network process of each of the frames which haven been set in the input image, and outputs the classification result regarding whether or not a person is present in the input image, and further outputs the regression result regarding the upper end position, the lower end position, and the central position of the person when the person is present in the input image.

(By the way, a CNN process is disclosed by a non-patent document 2, Y. LeCun, B. Boser, J. S. Denker, D. Henderson, R. E. Howard, W. Hubbard, and L. D. Jackel, “Handwritten Digit Recognition with a Back-Propagation Network”, Advances in Neural Information Processing Systems (NIPS), pp. 396-404, 1990.)

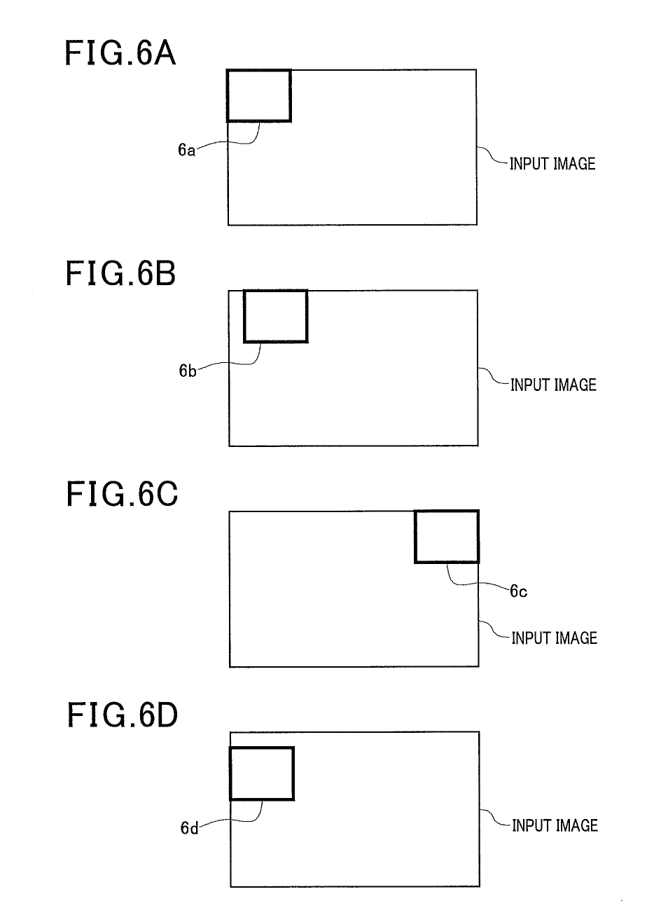

FIG. 6A to FIG. 6D are views showing the process performed by the neural network processing section 22 in the detection device 2 according to the first exemplary embodiment.

As shown in FIG. 6A, the neural network processing section 22 generates or sets up the frame 6a at the upper left hand corner in the input image. The frame 6a has a size which is equal to the size of the small sized image of the positive samples and the negative samples. The neural network processing section 22 performs the process of the frame 6a.

As shown in FIG. 6B, the neural network processing section 22 generates or sets up the frame 6b at the location which is slightly shifted from the location of the segment 6a so that a part of the frame 6a is overlapped with the segment 6a. The frame 6b has the same size of the frame 6a. The neural network processing section 22 performs the process of the frame 6b.

Next, the neural network processing section 22 performs the process while sliding the position of the frame toward the right direction. When finishing the process of the frame 6c generated or set up at the upper right hand corner shown in FIG. 6C, the neural network processing section 22 generates or sets up the frame 6d at the left hand side shown in FIG. 6D so that the frame 6d is arranged slightly lower than the frame 6a and a part of the frame 6d is overlapped with the frame 6a.

While sliding the frames from the left hand side to the right hand side and from the upper side to the lower side in the input image, the neural network processing section 22 continues the process. These frames are also called as the “sliding windows”.

The weighted values W stored in the memory section 21 have been calculated on the basis of a plurality of the positive samples and the negative samples having different sizes. It is accordingly possible for the neural network processing section 22 to use the frames as the sliding windows having a fixed size in the input image. It is also possible for the neural network processing section 22 to process a plurality of pyramid images w obtained by resizing the input image. Further, it is possible for the neural network processing section 22 to process a smaller number of input images with high accuracy. It is possible for the neural network processing section 22 to quickly perform the processing of the input image with a small processing amount.

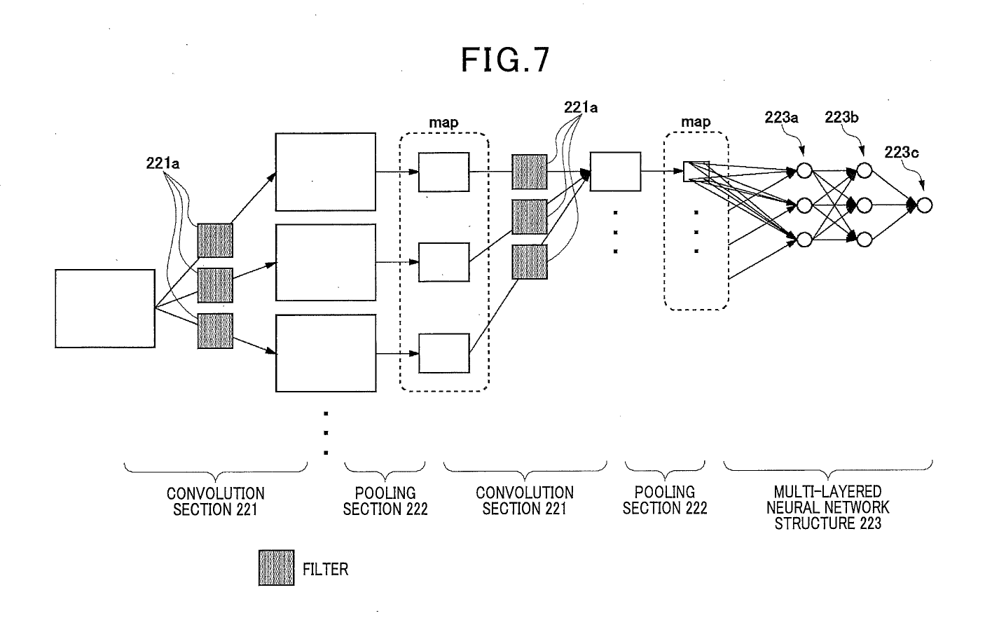

FIG. 7 is a view showing a structure of the convolution neural network (CNN) used by the neural network processing section 22 in the detection device 2 according to the first exemplary embodiment.

The CNN has one or more pairs of a convolution section 221 and a pooling section 222, and a multi-layered neural network structure 223.

The convolution section 221 performs a convolution process in which a filter 221a is applied to each of the sliding windows. The filter 221a is a weighted value consisting of elements (n pixels)×(n pixels) where, n is a positive integer, for example, n=5. It is acceptable for each weighted value to have a bias. As previously described, the parameter calculation section 5 has calculated the weighted values and stored the calculated weighted values into the memory section 21.

Non-linear maps of convoluted values are calculated by using an activation function such as the sigmoid function. The signals of the calculated non-linear maps are used as image signals in a two dimensional array.

The pooling section 222 performs the pooling process to reduce a resolution of the image signals transmitted from the convolution section 221.

A description will now be given of a concrete example of the pooling process. The pooling section 222 divides the 2-dimensional array into 2×2 grids, and performs a pooling of a maximum value (a max-pooling) of the 2×2 grids in order to extract a maximum value in four signal values of each grid. This pooling process reduces the size of the two-dimensional array into a quarter size. Thus, the pooling process makes it possible to compress information without removing any feature of the position information in an image. The pooling process generates the two-dimensional map. A combination of the obtained maps forms a hidden layer (or an intermediate layer) in the CNN.

A description will now be given of other concrete examples of the pooling process. It is possible for the pooling section 222 to perform the max-pooling process of extracting one element (for example, (1, 1) element at the upper left side) from the 2×2 grids. It is also acceptable for the pooling section 222 to extract a maximum element from the 2×2 grids. Further, it is possible for the pooling section 222 to perform the max-pooling process while overlapping the grids together. In these examples can reduce the convoluted two-dimensional array

A usual case uses a plurality of pairs of the convolution section 221 and the pooling section 222. The example shown in FIG. 7 has two pairs of the convolution section 221 and the pooling section 222. It is possible to have one pair or not less than three pairs of the convolution section 221 and the pooling section 222.

After the convolution section 221 and the pooling section 222 adequately compress the sliding windows, the multi-layered neural network structure 223 performs a usual neural network process (without convolution).

The multi-layered neural network structure 223 has the input layers 223a, one or more hidden layers 223b and the output layer 223c. The input layers 223a input image signals compressed by and transmitted from the convolution section 221 and the pooling section 222. The hidden layers 223b perform a product-sum process of the input image signals by using the weighted values W stored in the memory section 21. The output layer 223c outputs the final result of the neural network process.

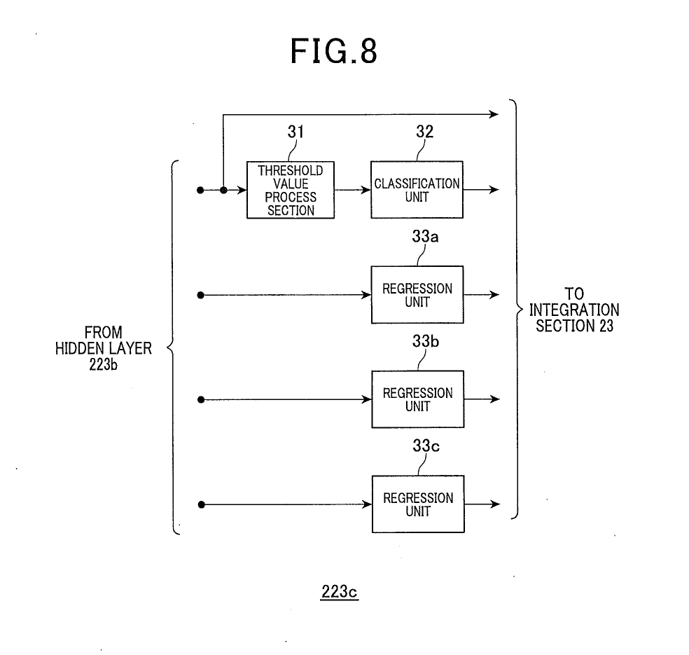

FIG. 8 is a view showing a schematic structure of the output layer 223c in the multi-layered neural network structure 223 shown in FIG. 7. As shown in FIG. 8, the output layer 223c has a threshold value process section 31, a classification unit 32, and regression units 33a to 33c.

The threshold value process section 31 inputs values regarding the classification result transmitted from the hidden layers 223b. Each of the values is within not less than 0 and not more than 1. The more the value approaches 0, the more a probability that a person is present in the input image becomes low. On the other hand, the more the value approaches 1, the more a probability that a person is present in the input image becomes high. The threshold value process section 31 compares the value with a predetermined threshold value, and sents a value of 0 or 1 into the classification unit 32. As will be described later, it is possible for the integration section 23 to use the value transmitted to the threshold value process section 31.

The hidden layers 223b provides, as the regression results, the upper end position, the lower end position, and the central position of the person into the regression units 33a to 33c. It is also possible to provide optional values as each position into the regression units 33a to 33c.

The neural network processing section 22 previously described outputs information regarding whether or not a person is present, the upper end position, the lower end position and the central position of the person per each of the sliding windows. The information will be called as real detection results.

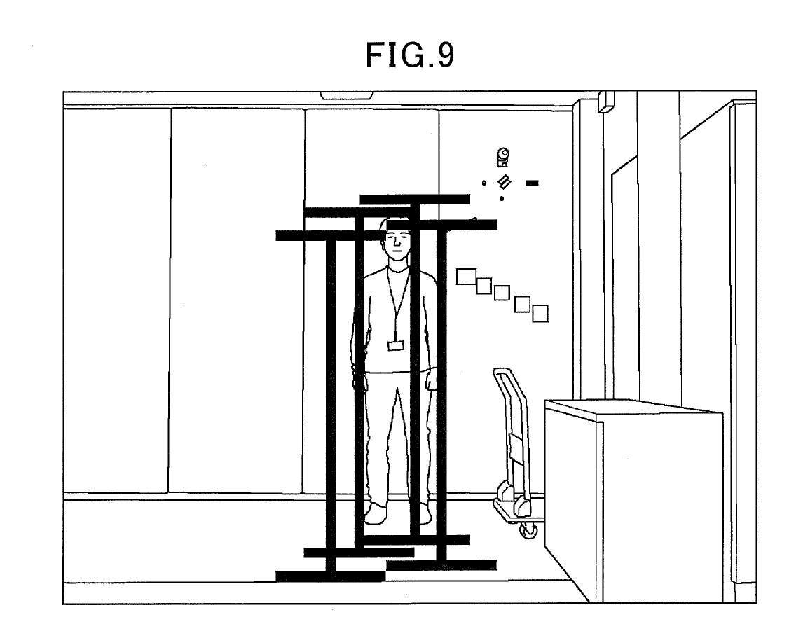

FIG. 9 is a view showing an example of real detection results detected by the detection device 2 according to the first exemplary embodiment.

FIG. 9 shows a schematic location of the upper end position, the lower end position, and the central position of a person in the image by using characters I. The schematic location of the person shown in FIG. 9 shows correct detection results and incorrect detection results. For easy understanding, FIG. 9 shows several detection results only for easy understanding. A concrete sample uses a plurality of sliding windows to classify the presence of a person in the input image.

A description will now be given of a detailed explanation of the integration section 23 shown in FIG. 2.

At a first stage, the integration section 23 performs a grouping of the detection results of the sliding windows when the presence of a person is classified (or recognized). The grouping gathers the same detection results of the sliding windows into a same group.

In a second stage, the integration section 23 integrates the real detection results in the same group as the regression results of the position of the person.

The second state makes it possible to specify the upper end position, the lower end position and the central position of the person even if several persons are present in the input image. The detection device 2 according to the first exemplary embodiment can directly specify the lower end position of the person on the basis of the input image.

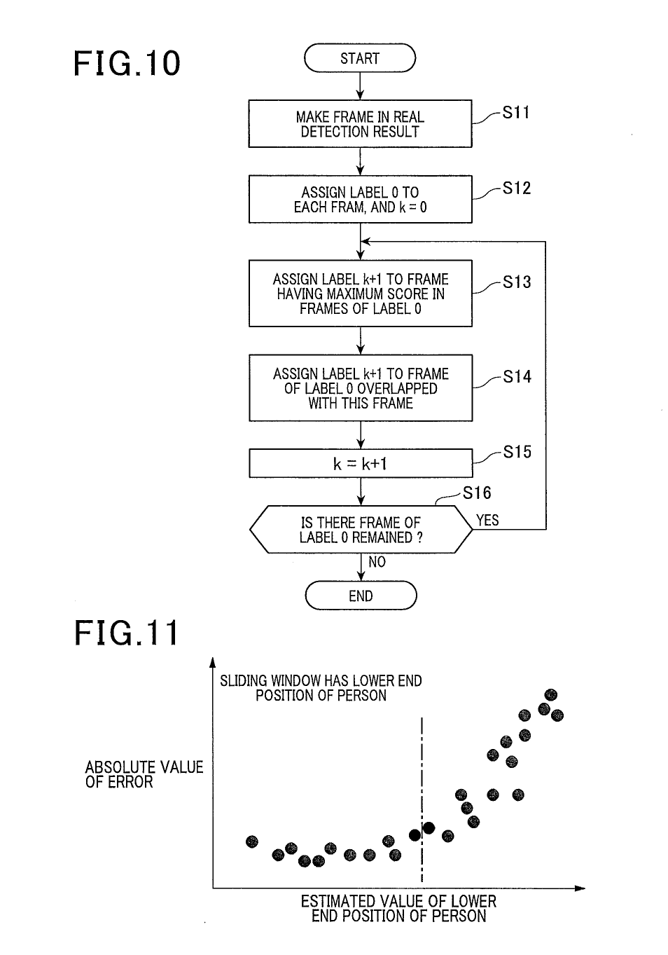

A description will now be given of the grouping process in the first stage with reference to FIG. 10.

FIG. 10 is a flow chart showing the grouping process performed by the integration section 23 in the detection device 2 according to the first exemplary embodiment of the present invention.

In step S11, the integration section 23 makes a rectangle frame for each of the real detection results. Specifically, the integration section 23 determines an upper end position, a bottom end position and a central position in a horizontal direction of each rectangle frame of the real detection result so that the rectangle frame is fitted to the upper end position, the bottom end position and the central position of the person as the real detection result. Further, the integration section 23 determines a width of the rectangle frame to have a predetermined aspect ratio (for example, Width:Height=0.4:1). In other words, the integration section 23 determines the width of the rectangle frame on the basis of a difference between the upper end position and the lower end position of the person. The operation flow goes to step S12.

In step S12, the integration section 23 adds a label of 0 to each rectangle frame, and initializes a parameter k, i.e. assigns zero to the parameter k. Hereinafter, the frame to which the label k is assigned will be referred to as the “frame of the label k”. The operation flow goes to step S13.

In step S13, the integration section 23 assigns a label k+1 to a frame having a maximum score in the frames of the label 0. The high score indicates a high detection accuracy. For example, the more the value before the process of the threshold value process section 31 shown in FIG. 8 approaches the value of 1, the more the score of the rectangle frame is high. The operation flow goes to step S14.

In step S14, the integration section 23 assign the label k+1 to the frame which is overlapped with the frame.

In order to judge whether or not the frame is overlapped with the frame of the label k+1, it is possible for the integration section 23 to perform a threshold judgment of a ratio between an area of a product of the frames and an area of a sum of the frames. The operation flow goes to step S15.

In step S15, the integration section 23 increments the parameter k by one. The operation flow goes to step S16.

In step S16, the integration section 23 detects whether or not there is a remaining frame of the label 0.

When the detection result in step S16 indicates negation (“NO” in step S16), the integration section 23 completes the series of the processes in the flow chart shown in FIG. 10.

On the other hand, when the detection result in step S16 indicates affirmation (“YES” in step S16), the integration section 23 returns to the process in step S13. The integration section 23 repeatedly performs the series of the processes previously described until the last frame of the label 0 has been processed. The processes previously described make it possible to classify the real detection results into k groups. This means that there are k persons in the input image.

It is also possible for the integration section 23 to calculate an average value of the upper end position, an average value of the lower end position and an average value of the central position of the person in each group, and to integrate them.

It is further acceptable to calculate an average value of an average value of a cut upper end position, an average value of a cut lower end position and an average value of a cut central position of the person in each group, and to integrate them. That is, it is possible for the integration section 23 to remove a predetermined ratio of each of the upper end position, the lower end position and the central position of the person in each group, and to obtain an average value of the remained positions.

Still further, it is possible for the integration section 23 to calculate an average value of a position of the person having a highly estimation accuracy.

It is possible for the integration section 23 to calculate an estimation accuracy on the basis of validation data. The validation data has supervised data, is not use for learning. Performing the detection and regression of the validation data allows estimation of the estimation accuracy.

FIG. 11 is a view explaining an estimation accuracy of the lower end position of a person. The horizontal axis indicates an estimated value of the lower end position of the person, and the vertical axis indicates an absolute value of an error (which is a difference between a true value and an estimated value). As shown in FIG. 11, when an estimated value of the lower end position of the person relatively increases, the absolute value of the error is increased. The reason why the absolute value of the error increases is as follows. When the lower end position of a person is small, because the lower end of the person is contained in a sliding window and the lower end position of the person is estimated on the basis of the sliding window containing the lower end of the person, the detection accuracy of the lower end position increases. On the other hand, when the lower end position of a person is large, because the lower end of the person is not contained in a sliding window and the lower end position of the person is estimated on the basis of the sliding window which does not contain the lower end of the person, the detection accuracy of the lower end position decreases.

It is possible for the integration section 23 to store a relationship between estimated values of the lower end position and errors, as shown in FIG. 11, and calculate an average value with a weighted value on the basis of the error corresponding to the lower end position estimated by using each sliding window.

For example, it is acceptable to use, as the weighted value, an inverse number of the absolute value of the error or a reverse number of a mean square error, or use a binary value corresponding to whether or not the estimated value of the lower end position exceeds a predetermined threshold value.

It is further possible to use a weighted value of a relative position of a person in a sliding window which indicates whether or not the sliding window contains the upper end position or the central position of the person.

As a modification of the detection device 2 according to the first exemplary embodiment, it is possible for the integration section 23 to calculate an average value with a weighted value of the input value shown in FIG. 8, which is used by the process of the neural network processing section 22. The more this average value with a weighted value of the input value approaches the value of 1, the more the possibility of the person present in the input image becomes high, and the more the estimated accuracy of the position of the person becomes high.

As previously described in detail, when the input image contains a person, it is possible to specify the upper end position, the lower end position and the central position of the person in the input image. The detection device 2 according to the first exemplary embodiment detects the presence of a person in a plurality of sliding windows, and integrates the real detection results in these sliding windows. This makes it possible to statically and stably obtain estimated detection results of the person in the input image.

A description will now be given of the calculation section 24 shown in FIG. 2 in detail. The calculation section 24 calculates a distance between the vehicle body 4 of the own vehicle and the person (or a pedestrian) on the basis of the lower end position of the person obtained by the integration section 23.

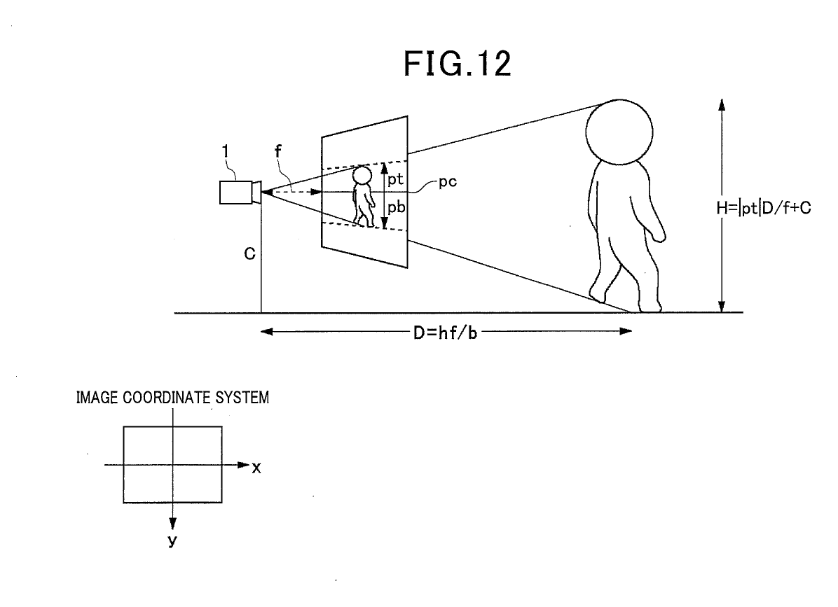

FIG. 12 is a view showing a process performed by the calculation section 24 in the detection device 2 according to the first exemplary embodiment. When the following conditions are satisfied:

The in-vehicle camera 1 is arranged at a known height C (for example, C=130 cm height) in the own vehicle;

The in-vehicle camera 1 has a focus distance f;

In an image coordinate system, the origin is the center position of the image, the x axis indicates a horizontal direction, and the y axis indicates a vertical direction (positive/downward); and

Reference character “pb” indicates the lower end position of a person obtained by the integration section 23.

In the conditions previously described, the calculation section 24 calculates the distance D between the in-vehicle camera 1 and the person on the basis of a relationship of similar triangles by using the following equation (5).

D=hf/pb (5).

The calculation section 24 converts, as necessary, the distance D between the in-vehicle camera 1 and the person to a distance D′ between the vehicle body 4 and the person.

It is acceptable for the calculation section 24 to calculate the height of the person on the basis of the upper end position pt (or a top position) of the person. As shown in FIG. 12, the calculation section 24 calculates the height H of the person on the basis of a relationship of similar triangles by using the following equation (6).

H=|pt|D/f+C (6).

It is possible to judge whether the detected person is a child or an adult.

A description will now be given of the image generation section 25 shown in FIG. 2.

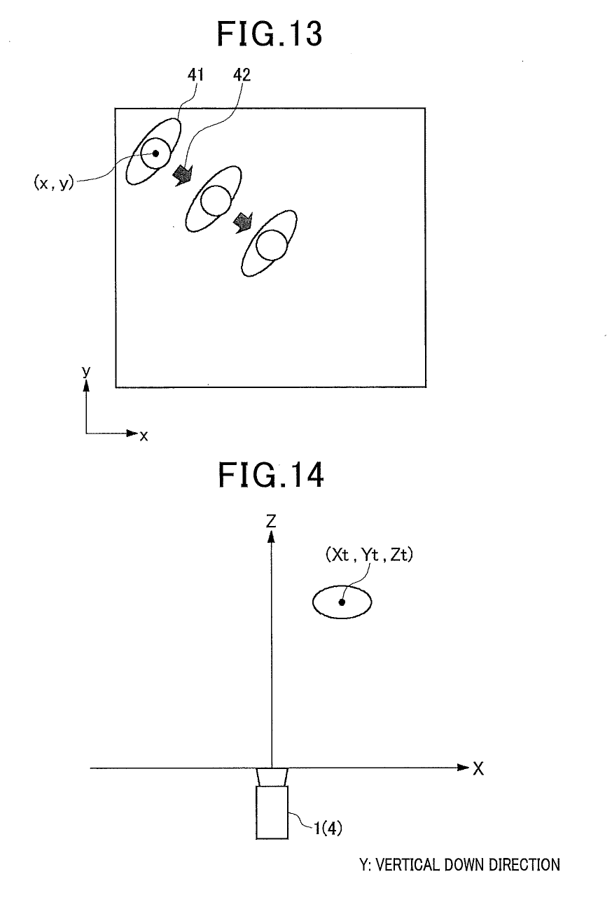

FIG. 13 is a view showing schematic image data generated by the image generation section 25 in the detection device 2 according to the first exemplary embodiment.

When the detection device 2 classifies or recognizes the presence of a person (for example, a pedestrian) in the image obtained by the in-vehicle camera 1, the image generation section 25 generates image data containing a mark 41 corresponding to the person in order to display the mark 41 on the display device 3. The horizontal coordinate x of the mark 41 in the image data is on the basis of the horizontal position of the person obtained by the integration section 23. In addition, the vertical coordinate y of the mark 41 is on the basis of the distance D between the in-vehicle camera 1 and the person (or the distance D′ between the vehicle body 4 and the person).

Accordingly, it is possible for the driver of the own vehicle to correctly classify (or recognize) whether or not a person (such as a pedestrian) is present in front of the own vehicle on the basis of the presence of the mark 41 in the image data.

Further, it is possible for the driver of the own vehicle to correctly classify or recognize where the person is around on the basis of the horizontal coordinate x and the vertical coordinate y of the mark 41.

It is acceptable for the in-vehicle camera 1 to continuously obtain the front scene in front of the own vehicle in order to correctly classify (or recognize) the moving direction of the person. It is accordingly possible for the image data to contain the arrows 42 which indicates the moving direction of the person shown in FIG. 13.

Still further, it is acceptable to use different marks which indicate an adult or a child on the basis of the height H of the person calculated by the calculation section 24.

The image generation section 25 outputs the image data previously described to the display device 3, and the display device 3 displays the image shown in FIG. 13 thereon.

As previously described in detail, the detection device 2 and the method according to the first exemplary embodiment perform the neural network process using a plurality of positive samples and negative samples which contain a part or the entire of a person (or a pedestrian), and detect whether or not a person is present in the input image and determines a location of the person (for example, the upper end position, the lower end position and the central position of the person) when the input image contains the person. It is therefore possible for the detection device 2 to correctly detect the person with high accuracy even if a part of the person is hidden without generating one or more partial models in advance.

It is also possible to use a program, to be executed by a central processing unit (CPU), which corresponds to the functions of the detection device 2 and the method according to the first exemplary embodiment previously described.

### Second Exemplary Embodiment

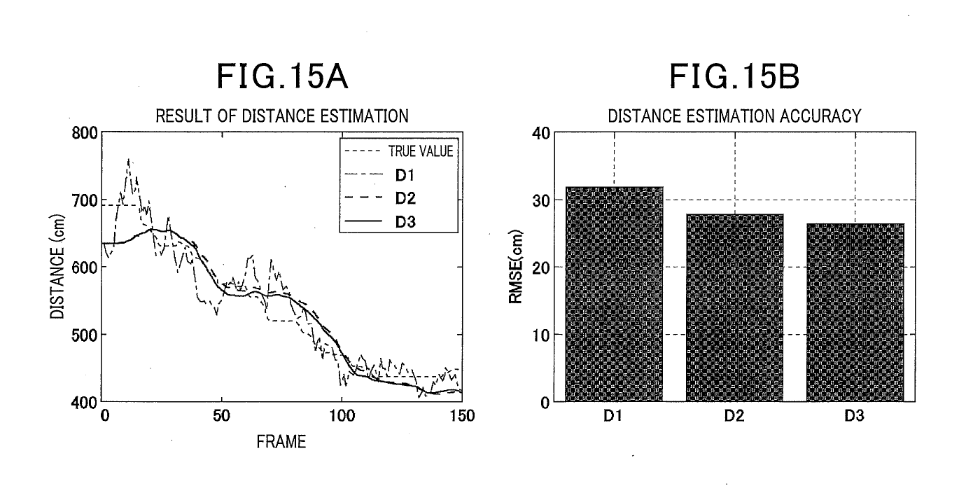

A description will be given of the detection device 2 according to a second exemplary embodiment with reference to FIG. 14, FIG. 15A and FIG. 15B. The detection device 2 according to the second exemplary embodiment has the same structure as the detection device 2 according to the first exemplary embodiment previously described.

The detection device 2 according to the second exemplary embodiment corrects the distance D between the in-vehicle camera 1 (see FIG. 1) and a person (pedestrian) on the basis of detection results using a plurality of frames (frame images) obtained in the input images transmitted from the in-vehicle camera 1.

The neural network processing section 22 and the integration section 23 in the detection device 2 shown in FIG. 2 specify the central position pc of the person, the upper end position pt of the person, and the lower end position pb of the person in the input image transmitted from the in-vehicle cameral 1. As can be understood from the equation (5) and FIG. 12, it is sufficient to use the lower end position pb of the person in order to calculate the distance D between the vehicle body 4 of the own vehicle (or the in-vehicle camera 1 mounted on the own vehicle) and the person. However, the detection device 2 according to the second exemplary embodiment uses the upper end position pt of the person in addition to the lower end position pb of the person in order to improve the estimation accuracy of the distance D (or the distance estimation accuracy).

The calculation section 24 in the detection device 2 according to the second exemplary embodiment calculates a distance Dt and a height Ht of the person on the basis of the central position pc, the upper end position pt and the lower end position pb of the person in the input image specified by the neural network process and the integration process of the frame at a timing t.

Further, the calculation section 24 calculates the distance Dt+1 and the Height Ht+1 of the person on the basis of the central position pc, the upper end position pt and the lower end position pb of the person in the input image specified from the frame at a timing t+1. In general, because the height of the person is a constant value, i.e. is not variable, the height Ht is approximately equal to the height Ht+1. Accordingly, it is possible to correct the distance Dt and the distance Dt+1 on the basis of the height Ht and the height Ht+1. This makes it possible for the detection device 2 to increase the detection accuracy of the distance Dt and the distance Dt+1.

A description will now be given of the correction process of correcting the distance D by using an extended Kalman filter (EKF). In the following explanation, a roadway on which the own vehicle drives is a flat road.

FIG. 14 is a view explaining a state space model to be used by the detection device 2 according to the second exemplary embodiment.

As shown in FIG. 14, the optical axis of the in-vehicle camera 1 is the Z axis, the Y axis indicates a vertical down direction, and the X axis is perpendicular to the Z axis and the Y axis. That is, the X axis is a direction determined by a horizontal direction right-handed coordinate system.

The state variable xt is determined by the following equation (7).

$${x}_{t} = [ \begin{matrix}{Z}_{t} \\ {X}_{t} \\ {Z}_{t}^{′} \\ {X}_{t}^{′} \\ {H}_{t}\end{matrix} ] \qquad ( 7 )$$

where, Zt indicates a Z component (Z position) of the position of the person which corresponds to the distance D between the person and the in-vehicle camera 1 mounted on the vehicle body 4 of the own vehicle shown in FIG. 12. The subscript “t” in the equation (7) indicates a value at a timing t. Other variables have the subscript “t”. For example, Xt indicates a X component (X position) of the position of the person. Zt′ indicates a Z component (Z direction speed) of a walking speed of the person and a time derivative of a Z position Zt of the person. Xt′ indicates a X component (X direction speed) of a walking speed of the person and a time derivative of a X position Xt of the person. Hi indicates the height of the person.

An equation which represents the time expansion of the state variable xt is known as a system model. For example, the system model shows time invariance of a height of the person on the basis of a uniform linear motion model of the person. That is, the time expansion of the variables Zt, Xt, Zt′ and Xt′ are given by a uniform linear motion which uses a Z component Zt″ (Z direction acceleration) and a X component Xt″ (Z direction acceleration) of an acceleration using system noises. On the other hand, because the height of the person is not increased or decreased with time in the captured images even if the person is walking, the height of the person does not vary with time. However, because there is a possible case in which the height of the person slightly varies when the person bends his knees, it is acceptable to use a system noise ht regarding noise of the height of the person.

As previously described, for example, it is possible to express the system model by using the following equations (8) to (13). The images captured by the in-vehicle camera 1 are sequentially or successively processed at every time interval 1 (that is, every one frame).

$$\begin{matrix}{x}_{t + 1} = {Fx}_{t} + {Gw}_{t} & ( 8 ) \\ F = [ \begin{matrix}1 & 0 & 1 & 0 & 0 \\ 0 & 1 & 0 & 1 & 0 \\ 0 & 0 & 1 & 0 & 0 \\ 0 & 0 & 0 & 1 & 0 \\ 0 & 0 & 0 & 0 & 1\end{matrix} ] & ( 9 ) \\ G = [ \begin{matrix}1 / 2 & 0 & 0 \\ 0 & 1 / 2 & 0 \\ 1 & 0 & 0 \\ 0 & 1 & 0 \\ 0 & 0 & 1\end{matrix} ] & ( 10 ) \\ {w}_{t} = [ \begin{matrix}{Z}_{t}^{″} \\ {X}_{t}^{″} \\ {h}_{t}\end{matrix} ] & ( 11 ) \\ {w}_{t} \sim 𝒩 ( 0 , Q ) & ( 12 ) \\ Q = [ \begin{matrix}{σ}_{Q}^{2} & 0 & 0 \\ 0 & {σ}_{Q}^{2} & 0 \\ 0 & 0 & {σ}_{H}^{2}\end{matrix} ] : & ( 13 )\end{matrix}$$

As shown by the equations (12) and (13), it is assumed that the system noise wt is obtained from a Gaussian distribution using an average value of zero. The system noise wt is isotropy in X direction and Y direction. Each of the Z component Zt″ (Z direction acceleration) and the X component Xt″ (Z direction acceleration) has a dispersion ρ₀².

On the other hand, the height Ht of the person usually has a constant value. Sometimes, the height Ht of the person slightly varies, i.e. has a small time variation when the person bends his knees, for example. Accordingly, the dispersion σ_{H}² of the height Ht of the person is adequately smaller than the dispersion σ_{Q}² or has zero in the equation (13).

The first row in the equation (7), i.e. the equation (8) can be expressed by the following equation (8a).

Zt+1=Zt+Zt′+Zt″/2 (8a).

The equation (8a) shows a time expansion of the variation of the Z position of the person in a usual uniform linear motion. That is, the Z position Zt+1 (the left hand side in the equation (8a) of the person at a timing t+1 is changed from the Z position Zt (the first term at the right hand side in the equation (8a)) of the person at a timing t by the movement amount Zt″/2 (the third term in the right hand side in the equation (8a)) obtained by the movement amount Zt′ of the speed (the second term in the right hand side in the equation (8a)) and the movement amount Zt″/2 (the third term in the right hand side in the equation (8a)) obtained by the acceleration (system noise). The second row in the equation (7) as the equation (8) can be expressed by the same process previously described.

The third row in the equation (7) as the equation (8) can be expressed by the following equation (8b).

Zt+1′=Zt′+Zt″ (8b).

The equation (8b) shows the speed time expansion of the Z direction speed in the usual uniform linear motion. That is, the Z direction speed Zt+1′ (the left hand side in the equation (8b)) at a timing t+1 is changed from the Z direction speed Zt′ (the first term at the right hand side in the equation (8b)) at a timing t by the Z direction acceleration Zt″ (system noise). The fourth row in the equation (7), i.e. the equation (8) can be expressed by the same process previously described.

The fifth row in the equation (7), i.e. the equation (8) can be expressed by the following equation (8c).

Ht+1=Ht+ht (8c).

The equation (8c) shows the variation of the height Ht+1 of the person at the timing t1+1 which is changed from the height Ht of the person at the timing t1 by the magnitude of the system noise ht. As previously described, because the time variation of the height Ht of the person has a small value, the dispersion σ_{H}² has a small value in the equation (13) and the system noise ht in the equation (8c) has a small value.

A description will now be given of an observation model in an image plane. In the image plane, X axis is a right direction, and Y axis is a vertical down direction.

Observation variables can be expressed by the following equation (14).

$${y}_{t} = [ \begin{matrix}{cenX}_{t} \\ {toeY}_{t} \\ {topY}_{t}\end{matrix} ] \qquad ( 14 )$$

The variable “cenXt” in the equation (14) indicates a X component (the central position) of a central position of the person in the image which corresponds to the central position pc (see FIG. 12) of the person. The variable “toeYt” in the equation (14) indicates a Y component (the lower end position) of the lower end position of the person in the image which corresponds to the lower end position pb (see FIG. 12) of the person. The variable “topYt” in the equation (14) indicates a Y component (the upper end position) of the lower end position of the person in the image which corresponds to the upper end position pt (see FIG. 12) of the person.

The observation model corresponds to the equation which expresses a relationship between the state variable xt and the observation variable yt. As shown in FIG. 12, a perspective projection image using the focus distance f of the in-vehicle camera 1 and the Z position Zt (which corresponds to the distance D shown in FIG. 12) corresponds to the relationship between the state variable xt and the observation variable yt.

A concrete observation model containing observation noise vt can be expressed by the following equation (15).

$$\begin{matrix}{y}_{t} = h ( {x}_{t} ) + {v}_{t} & ( 15 ) \\ h ( {x}_{t} ) = [ \begin{matrix}{fX}_{t} / {Z}_{t} \\ fC / {Z}_{t} \\ f ( C - {H}_{c} ) / {Z}_{t}\end{matrix} ] & ( 16 ) \\ {v}_{t} \sim 𝒩 ( 0 , {R}_{t} ) & ( 17 ) \\ {R}_{t} = [ \begin{matrix}{{σ}_{x} ( t )}^{2} & 0 & 0 \\ 0 & {{σ}_{y} ( t )}^{2} & 0 \\ 0 & 0 & {{σ}_{y} ( t )}^{2}\end{matrix} ] & ( 18 )\end{matrix}$$

It is assumed that the observation noise vt in the observation model can be expressed by a Gaussian distribution with an average value of zero, as shown in the equation (17) and the equation (18).

The first row and the second row in the equation (14) as the equation (15) can be expressed by the following equations (15a) and (15b), respectively.

cenXt=fXt/Zt+N(0,σₓ(t)²) (15a), and

cenYt=fC/Zt+N(0,σ_{y}(t)²) (15a).

It can be understood from FIG. 12 to satisfy the relationship shown in the equations (14), (15a) and (15b), excepting the second term as the system noise N (0, σₓ(t)²) and N (0, σ_{y} (t)²) in the right hand side of the equations (15a) and (15b). As previously described, the central position cenXt of the person is a function of the Z position Zt and the X position Xt of the person, and the lower end position toeYt of the person is a function of the Z position Zt.

The third row in the equation (14), i.e. the equation (15) can be expressed by the following equation (15c).

topYt=f(C−Ht)/Zt+N(0,σ_{y}(t)²) (15c).

It is important that the upper end position topYt is a function of the height Ht of the person in addition to the Z position Zt. This means that there is a relationship between the upper end position topYt and the Z position Zt (i.e. the distance D between the vehicle body 4 of the won vehicle and the person) through the height Ht of the person. This suggests that the estimation accuracy of the upper end position topYt affects the estimation accuracy of the distance D.

The data regarding the central position cenXt, the upper end position topYt and the lower end position toeYt as the results of processing one frame at a timing t transmitted from the integration section 23 are inserted into the left side in the equation (15), i.e. the equation (14). In this case, when all the observation noise is set to zero, the Z position Zt, the X position Xt and the height Ht of the person per one frame can be obtained.

Next, the data regarding the central position cenXt+1, the upper end position topYt+1 and the lower end position toeYt+1 as the results of processing one frame at a timing t+1 transmitted from the integration section 23 are inserted into the left side in the equation (15) as the equation (14). In this case, when all of the observation noises are set to zero, the Z position Zt+1, the X position Xt+1 and the height Ht+1 of the person per one frame image can be obtained.

Because each of the data Zt, Xt and Ht at the timing t and the data Zt+1, Xt+1 and Ht+1 at the timing t+1 is obtained per one frame image only, the accuracy of the data has not always high and there is a possible case which does not satisfy the system model shown by the equation (8).

In order to increase the estimation accuracy, the calculation section 24 estimates the data Zt, Xt, Zt, Xt′ and Ht on the basis of the observation values previously obtained so as to satisfy the state space model consisting of the system model (the equation (8)) and the observation model (the equation (15)) by using the known extended Kalman filter (EKF) while considering that the height Ht, Ht+1 of the person is a constant value, i.e. does not vary with time. The obtained estimated values Zt, Xt and Ht of each state are not in general equal to the estimated value obtained by one frame image. The estimated values in the former case are optimum values calculated by considering the motion model of the person and the height of the person. This increases the accuracy of the Z direction position Zt of the person. On the other hand, the estimated values in the latter case are calculated without considering any motion model of the person and the height of the person.

An experimental test was performed in order to recognize the correction effects by the detection device 2 according to the present invention. In the experimental test, a fixed camera captured video image when a pedestrian was walking. Further, an actual distance between the fixed camera and the pedestrian was measured.

The detection device 2 according to the second exemplary embodiment calculates (A1) the distance D1, (A2) the distance D2 and (A3) the distance D3 on the basis of the captured video image.

(A1) The distance D1 estimated per frame in the captured video image on the basis of the lower end position pb outputted from the integration section 23;
(A2) The distance D2 after correction obtained by solving the state space model by using the extended Kalman filter (EKF) after the height Ht is removed from the state variable in the equation (7) and the third row expressed by the equation (15c) is removed from the observation model expressed by the equation (15), i.e. the equation (14); and
(A3) The distance D3 after correction obtained by the detection device 2 according to the second exemplary embodiment.

FIG. 15A is a view showing the experimental results of the distance estimation performed by the detection device 2 according to the second exemplary embodiment. FIG. 15B is a view showing the experimental results of the accuracy of the distance estimation performed by the detection device 2 according to the second exemplary embodiment.

As shown in FIG. 15A, the distance D1 without correction has a large variation. On the other hand, the distance D2 and the distance D3 have a low variation as compared with that of the distance D1. In addition, as shown in FIG. 15B, the distance D3 has a minimum error index RMSE (Root Mean Squared Error) against a true value, which is improved from the error index of the distance D1 by approximately 16.7% of percentages, and from the error index of the distance D2 by approximately 5.1% of percentages.

As previously described in detail, the neural network processing section 22 and the integration section 23 in the detection device 2 according to the second exemplary embodiment specify the upper end position topYt in addition to the lower end position toeY of the person. The calculation section 24 adjusts, i.e. corrects the Z direction position Zt (the distance D between the person and the vehicle body 4 of the own vehicle) on the basis of the results specified by using the frame images and on the basis of the assumption in which the height Ht of the person does not vary, i.e. has approximately a constant value. It is accordingly possible for the detection device 2 to estimate the distance D with high accuracy even if the in-vehicle camera 1 is an in-vehicle monocular camera.

The second exemplary embodiment shows a concrete example which calculates the height Ht of the person on the basis of the upper end position topYt. However, the concept of the present invention is not limited by this. It is possible for the detection device 2 to use the position of another specific part of the person and calculate the height Ht of the person on the basis of the position of the specific part of the person. For example, it is possible for the detection device 2 to specific the position of the eyes of the person and calculate the height Ht of the person by using the position of the eyes of the person while assuming the distance between the eyes and the lower end position of the person is a constant value.

Although the first exemplary embodiment and the second exemplary embodiment use an assumption in which the road is a flat road surface, it is possible to apply the concept of the present invention to a case in which the road has a uneven road surface. When the road has a uneven road surface, it is sufficient for the detection device to combine detailed map data regarding an altitude of a road surface and a specifying device such as a GPS (Global Positioning System) receiver to specify an own vehicle location, and specify an intersection point between the lower end position of the person and the road surface.

The detection device 2 according to the second exemplary embodiment solves the system model and the observation model by using the extended Kalman filter (EKF). However, the concept of the present invention is not limited by this. It is possible for the detection device 2 to use the position of another specific part of the person and calculate the height Ht of the person on the basis of the position of the specific part of the person. For example, it is possible for the detection device 2 to use another method of solving the state space model by using time-series observation values.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A detection device comprising a neural network processing section capable of performing a neural network process using predetermined parameters in order to calculate and output a classification result and a regression result of each of a plurality of frames in an input image, the classification result representing a presence of a person in the input image, and the regression result representing a position of the person in the input image,
wherein the parameters are determined on the basis of a learning process using a plurality of positive samples and negative samples, each of the positive samples comprising a set of a segment of a sample image containing at least a part of a person and a true value of the position of the person in the sample image, and each of the negative samples comprising a segment of the sample image containing no person.

2. The detection device according to claim 1, further comprising an integration section capable of integrating the regression results of the position of the person in the frames which have been classified to indicate the presence of the person, and specifying the position of the person in the input image.

3. The detection device according to claim 1, wherein the number of the parameters does not depend on the number of the positive samples or the number of negative samples.

4. The detection device according to claim 1, wherein the position of the person contains a lower end position of the person.

5. The detection device according to claim 4, further comprising a calculation section capable of calculating a distance between a vehicle body of an own vehicle and the person on the basis of the lower end position of the person, and the input image is obtained by an in-vehicle camera mounted in the vehicle body of the own vehicle.

6. The detection device according to claim 5, wherein the position of the person contains a specific part of the person, and
the calculation section corrects the distance between the person and the vehicle body of the own vehicle by using the position of the person at a timing t and the position of the person at the timing t+1 while assuming that a height measured from the lower end position of the person and a position of a specific part of the person has a constant value, where the position of the person at the timing t is obtained by processing the input image captured by at the timing t and transmitted from the in-vehicle camera, and the position of the person at the timing t+1 is obtained by processing the input image captured by at the timing t+1 and transmitted from the in-vehicle camera.

7. The detection device according to claim 6, wherein
the calculation section corrects the distance between the person and the vehicle body of the own vehicle by solving a state space model by using time-series observation values, the state space model comprises an equation which describes a system model and an equation which describes an observation model, the system model shows a time expansion of the distance between the person and the vehicle body of the own vehicle, and uses an assumption in which the height measured from the lower end position of the person to the specific part of the person has a constant value, the observation model shows a relationship between the position of the person and the distance between the person and the vehicle body of the own vehicle.

8. The detection device according to claim 6, wherein
the calculation section corrects the distance between the person and the vehicle body of the own vehicle by using an upper end position of the person as the specific part and the assumption in which the height of the person has a constant value.

9. The detection device according to claim 1, wherein the position of the person contains a central position of the person in a horizontal direction.

10. The detection device according to claim 1, wherein the integration section performs a grouping of the frames in which the person is present, and integrates regression results of the person in each of the grouped frames.

11. The detection device according to claim 1, wherein the integration section integrates the regression results of the position of the person on the basis of the regression results having a high regression accuracy in the regression results of the position of the person.

12. The detection device according to claim 1, wherein the parameters are determined so that a cost function having a first term and a second term converges, wherein the first term is used by a classification regarding whether or not the person is present in the input image, and the second term is used by a regression of the position of the person.

13. The detection device according to claim 12, wherein the position of the person includes positions of a plurality of parts of the person, and the second term has coefficients corresponding to the positions of the parts of the person, respectively.

14. A detection program capable of performing a neural network process using predetermined parameters executed by a computer, wherein the neural network process is capable of obtaining and outputting a classification result and a regression result of each of a plurality of frames in an input image, the classification result representing a presence of a person in the input image, and the regression result representing a position of the person in the input image, and
the parameters are determined on the basis of a learning process on the basis of a plurality of positive samples, each of the positive samples comprising a set of a segment in a sample image containing at least a part of the person and a true value of the position of the person in the sample image, and a plurality of negative samples, each of the negative samples comprising a segment of the sample image containing no person.

15. A detection method comprising steps of:
calculating parameters for use in a neural network process by performing a learning process on the basis of a plurality of positive samples and negative samples, each of the positive samples comprising a set of a segment of a sample image containing at least a part of the person and a true value of the position of the person in the sample images, and each of the negative samples comprising a segment of the sample image containing no person;
performing the neural network process using the parameters; and
outputting classification results of a plurality of frames in an input image, a classification result representing a presence of a person in the input image, and a regression result of a position of the person in the input image.

16. A vehicle comprising:
a vehicle body;
an in-vehicle camera mounted in the vehicle body and is capable of generating an image of a scene in front of the vehicle body;
a neural network processing section capable of inputting the image as an input image transmitted from the in-vehicle camera, performing a neural network process using predetermined parameters, outputting classification results and regression results of each of a plurality of frames in the input image, the classification results representing a presence of a person in the input image, and the regression results representing a lower end position of the person in the input image;
an integration section capable of integrating the regression results of the position of the person in the frames in which the person is presence, and specifying a lower end position of the person in the input image;
a calculation section capable of calculating a distance between the person and the vehicle body on the basis of the specified lower end position of the person; and
a display device capable of displaying an image containing the distance between the person and the vehicle body,
wherein the predetermined parameters are determined by learning on the basis of a plurality of positive samples and negative samples, each of the positive samples comprise a set of a segment of a sample image containing at least a part of the person and a true value of the position of the person in the sample images, and each of the negative samples comprise a segment of the sample image containing no person.

17. A parameter calculation device capable of performing learning of a plurality of positive samples and negative samples, in order to calculate parameters for use in a neural network process of an input image, wherein each of the positive samples comprises a set of a segment of a sample image containing at least a part of the person and a true value of the position of the person in the sample images, and each of the negative samples comprises a segment of the sample image containing no person.

18. A parameter calculation program, to be executed by a computer, of performing a function of a parameter calculation device capable of performing learning of a plurality of positive samples and negative samples, in order to calculate parameters for use in a neural network process of an input image,
wherein each of the positive samples comprises a set of a segment of a sample image containing at least a part of the person and a true value of the position of the person in the sample images, and each of the negative samples comprises a segment of the sample image containing no person.

19. A method of calculating parameters for use in a neural network process of an input image, by performing learning of a plurality of positive samples and negative samples, where each of the positive samples comprises a set of a segment of a sample image containing at least a part of the person and a true value of the position of the person in the sample images, and each of the negative samples comprises a segment of the sample image containing no person.
